(19) United States
(12) Patent Application Publication
(10) Pub. No.: US 2021/0069901 A1
(43) Pub. Date: Mar. 11, 2021

(54) CONTROL DEVICE, CONTROL METHOD, AND PROGRAM

(71) Applicant: NEC Corporation, Tokyo (JP)

(72) Inventors: Takahiro ODA, Tokyo (JP); Nobuhisa SHIRAISHI, Tokyo (JP)

(73) Assignee: NEC Corporation, Tokyo (JP)

(21) Appl. No.: 17/011,105

(22) Filed: Sep. 3, 2020

(30) Foreign Application Priority Data
Sep. 6, 2019 (JP) 2019-163010

(51) Int. Cl. B25J 9/16; G05D 1/02

(52) U.S. Cl. CPC B25J 9/163; B25J 9/1661; G05D 2201/0216; G05D 1/0217; G05D 1/0291

(57) ABSTRACT

An operation is appropriately executed according to a priority order of the operation. A control device includes an acquisition unit and a takeover instruction unit. The acquisition unit acquires a priority order of an operation being executed by each of a plurality of robots. The takeover instruction unit selects, among the plurality of robots, a robot executing a second operation having a lower priority order than a first operation being executed by a first robot, as a second robot that takes over and executes the first operation, when the first robot is not able to arrive at an end point of the first operation, and instructs the second robot to interrupt the second operation and take over the first operation.

This application is based upon and claims the benefit of priority from Japanese Patent Application No. 2019-163010, filed on Sep. 6, 2019, the disclosure of which is incorporated herein in its entirety by reference.

### TECHNICAL FIELD

The present disclosure relates to a control device, a control method, and a program for a transfer robot.

### BACKGROUND ART

In a factory or a warehouse, introduction of a transfer robot, represented by an automated guided vehicle (AGV) or the like, having an autonomous travel function is advancing. An autonomously traveling transfer robot has become high in function due to spread of an Internet of things (IOT) sensing device and the like. Thus, the autonomously traveling transfer robot contributes to automation of an operation.

Japanese Unexamined Patent Application Publication No. 2010-055183 describes an automatic transfer system in which a transfer robot automatically moves to a charging station when a battery remaining amount of the transfer robot becomes small.

However, with such a transfer robot, a transfer operation is not accomplished when an unexpected event such as a sudden fault or a rapid decrease of a battery remaining amount in a process of a transfer operation occurs.

For such a problem, International Publication No. WO2015/059739 suggests a transfer system that supervises occurrence of a failure event by regularly monitoring an actuation state of a transfer robot, and continues a transfer operation by cooperation of a plurality of transfer robots.

### SUMMARY

An example object of the present disclosure is to provide a control device, a control method, and a program that are able to appropriately execute an operation according to a priority order of the operation.

A control device according to an example aspect of the present disclosure includes: an acquisition unit that acquires a priority order of an operation being executed by each of a plurality of robots; and a takeover instruction unit that selects, among the plurality of robots, a robot executing a second operation having a lower priority order than a first operation being executed by a first robot, as a second robot that takes over and executes the first operation, when the first robot is not able to arrive at an end point of the first operation, and instructs the second robot to take over the first operation.

A control method according to an example aspect of the present disclosure includes: acquiring a priority order of an operation being executed by each of a plurality of robots; selecting, among the plurality of robots, a robot executing a second operation having a lower priority order than a first operation being executed by a first robot, as a second robot that takes over and executes the first operation, when the first robot is not able to arrive at an end point of the first operation; and instructing the second robot to take over the first operation.

A non-transitory recording medium according to an example aspect of the present disclosure records thereon a program, causing a computer to execute: acquisition processing of acquiring a priority order of an operation being executed by each of a plurality of robots; selection processing of selecting, among the plurality of robots, a robot executing a second operation having a lower priority order than a first operation being executed by a first robot, as a second robot that takes over and executes the first operation, when the first robot is not able to arrive at an end point of the first operation; and takeover instruction processing of instructing the second robot to take over the first operation.

### BRIEF DESCRIPTION OF THE DRAWINGS

Exemplary features and advantages of the present invention will become apparent from the following detailed description when taken with the accompanying drawings in which:

FIG. 1 is a functional block diagram illustrating one example of a functional configuration of a control device 100 according to a first example embodiment;

FIG. 2 is a diagram illustrating one example of an overview of a control system including a control device 200 according to a second example embodiment;

FIG. 3 is a table illustrating one example of operation information used in the second example embodiment;

FIG. 4 is a table illustrating one example of state information used in the second example embodiment;

FIG. 5 is a functional block diagram illustrating one example of a functional configuration of the control device 200 according to the second example embodiment;

FIG. 6 is a table illustrating one example of allocation information used in the second example embodiment;

FIG. 7 is a table illustrating one example of travel data used in the second example embodiment;

FIG. 8 is a table illustrating one example of robot information used in the second example embodiment;

FIG. 9 is a flowchart illustrating allocation processing of an operation according to the second example embodiment;

FIG. 10 is a flowchart illustrating takeover processing of an operation according to the second example embodiment;

FIG. 11 is a flowchart illustrating selection processing of a transfer robot according to the second example embodiment;

FIG. 12 is a functional block diagram illustrating one example of a functional configuration of a control device 201 according to a modification example of the second example embodiment; and

FIG. 13 is a diagram exemplarily describing a hardware configuration of a computer (information processing device) that can achieve each of the example embodiments.

### EXAMPLE EMBODIMENT

Each example embodiment of the present disclosure will be described by use of the drawings.

### First Example Embodiment

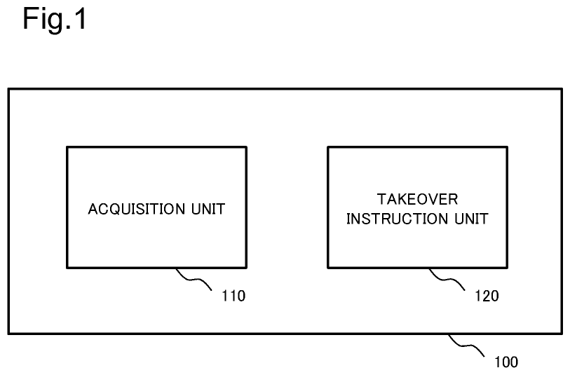

A first example embodiment is described with reference to a drawing. In the present example embodiment, a basic configuration that solves a problem is described. FIG. 1 is a functional block diagram illustrating one example of a functional configuration of a control device 100 according to the present example embodiment.

### [Configuration of Control Device 100]

As illustrated in FIG. 1, the control device 100 according to the present example embodiment includes an acquisition unit 110 and a takeover instruction unit 120.

The acquisition unit 110 acquires a priority order of an operation being executed by each of a plurality of robots. A method by which the acquisition unit 110 acquires a priority order of an operation is not particularly limited, and the acquisition unit 110 may acquire a priority order of an operation via a communication network, for example.

The takeover instruction unit 120 determines, among the plurality of robots, a robot executing a second operation having a lower priority order than a first operation being executed by a first robot, as a second robot that takes over and executes the first operation, when the first robot is not able to arrive at an end point of the first operation, and instructs the second robot to take over the first operation.

In a transfer system using a transfer robot, in a case where, when a failure occurs in the transfer robot, another transfer robot is actuating and there is no vacancy, a transfer operation interrupted by the failure is taken over after waiting for the another transfer robot to finish an operation.

In such a transfer system, when interruption occurs in a transfer operation, there is a fear that a great failure occurs depending on an urgency degree of a transfer article, or a decrease in operation efficiency is incurred at a transfer destination.

In the control device 100 according to the present example embodiment, when a first robot is not able to accomplish a first operation, a second robot executing a second operation having a lower priority order than the priority order of the first operation takes over the first operation.

Thus, the control device 100 is able to appropriately execute an operation according to a priority order of the operation.

### Second Example Embodiment

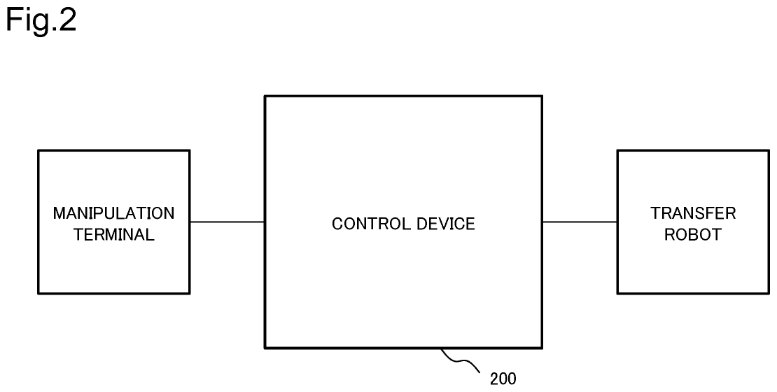

Next, a second example embodiment based on the above-described first example embodiment is described with reference to drawings. FIG. 2 is a diagram illustrating one example of an overview of a control system including a control device 200 according to the second example embodiment.

In the present example embodiment, the present invention is specifically described assuming that an operation executed by a robot is a transfer operation, but a purpose of the present invention is not particularly limited to a transfer operation. For example, as long as an operation is an operation that involves movement and can be taken over, the operation may be another operation such as an inventory operation, a detection operation, or an inspection operation.

### [Overview of Control Device 200]

As illustrated in FIG. 2, the control device 200 according to the present example embodiment is connected to at least one manipulation terminal and at least one robot, in such a way that data can be transmitted and received.

The manipulation terminal illustrated in FIG. 2 is connected to the control device 200 via a specific interface or a communication network. A user inputs, via the manipulation terminal, information relating to an operation to be executed by a transfer robot (hereinafter, also described as operation information). The input operation information is transmitted to the control device 200.

The manipulation terminal is able to receive, via the control device 200, information relating to a state being executed by the transfer robot (hereinafter, also described as state information). The received state information may be displayed on a display unit included in the manipulation terminal.

The transfer robot illustrated in FIG. 2 is connected to the control device 200 via a communication network. The transfer robot receives operation information, a control instruction, and the like from the control device 200. The transfer robot transmits state information and the like to the control device 200.

The transfer robot includes various sensors and devices. For example, the transfer robot includes a sensor that acquires position information such as a current position, a sensor or a camera that detects a surrounding object, a contact sensor, a fault detection device, an error detection device, and a communication device. Each transfer robot has, attached thereto, a robot ID for identifying the transfer robot.

Herein, for example, a universal serial bus (USB) or the like is cited as a specific interface. Either wired communication or wireless communication can be used as a communication network. Wired communication or wireless communication of any specification may be used as long as information necessary for a transfer robot is able to be transmitted and received to and from a communication network.

Operation information may include, for example, an operation kind, an operation ID, an operation priority order, position information, an operation target, and a start date and time.

State information may include, for example, a robot ID, a current position, a battery remaining amount, failure occurrence, and a time.

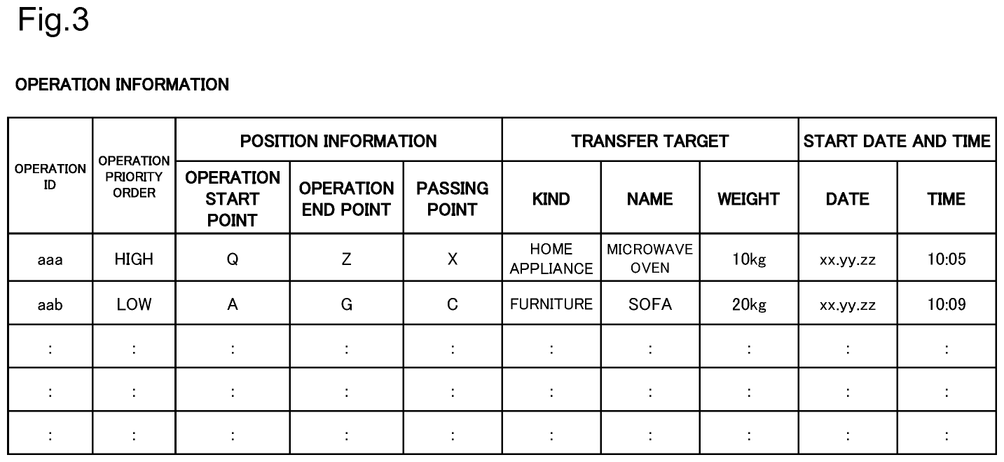

FIG. 3 is a table illustrating one example of operation information used in the present example embodiment. In this example, a transfer operation is previously selected as an operation kind. The operation information includes position information and a transfer target being relevant to a transfer operation, and a start date and time. In the present example embodiment, an operation kind is previously selected, but may be included in the operation information.

An operation ID is an ID unique to each operation. The operation ID is not limited to a unique combination of numerical values or a combination of alphabets, and may be a combination of alphabets and numerical values.

An operation priority order may be represented at two or more levels, and may be represented at, for example, three high, medium, and low levels, or may be classified into and represented at finer levels.

Position information includes, for example, an operation start point and an operation end point, and may further include a passing point. A transfer target includes, for example, a kind, a name, and a weight of a transfer article.

A start date and time may be a date and time when a user finishes inputting operation information, or may be a date and time when the user transmits operation information to the control device 200. The start date and time may be a date and time when the control device 200 transmits operation information to a transfer robot as an instruction for an operation, or may be a date and time when the transfer robot receives operation information. In the present example embodiment, a date and time when the manipulation terminal transmits operation information to the control device 200 is adopted.

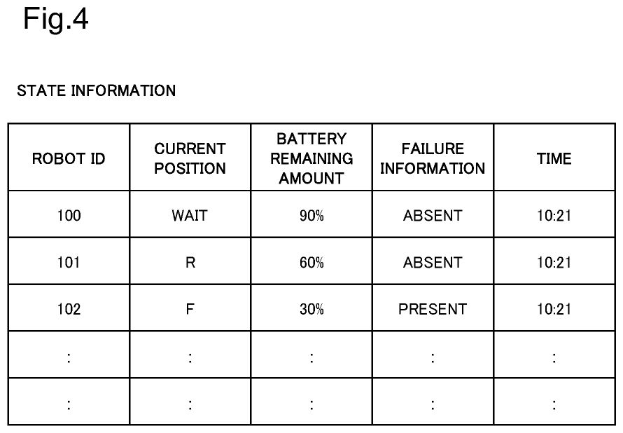

FIG. 4 is a table illustrating one example of state information used in the present example embodiment. In this example, state information of a transfer robot executing a transfer operation includes a robot ID, a current position, a battery remaining amount, failure information, and a time.

A robot ID is an ID unique to each robot. A robot ID is not limited to a unique combination of numerical values or alphabets, and may be a combination of alphabets and numerical values.

A current position is a position when a transfer robot transmits state information to the control device 200. Failure information indicates, to a transfer robot, presence or absence of a failure such as an error, a fault, a rapid decrease of a battery remaining amount, or the like. Failure information may include a type of a failure that occurs.

A time may be a time when a transfer robot transmits state information to the control device 200. The time may be a time when the control device 200 receives state information. In the present example embodiment, a time when a transfer robot transmits state information to the control device 200 is adopted.

### [Configuration of Control Device 200]

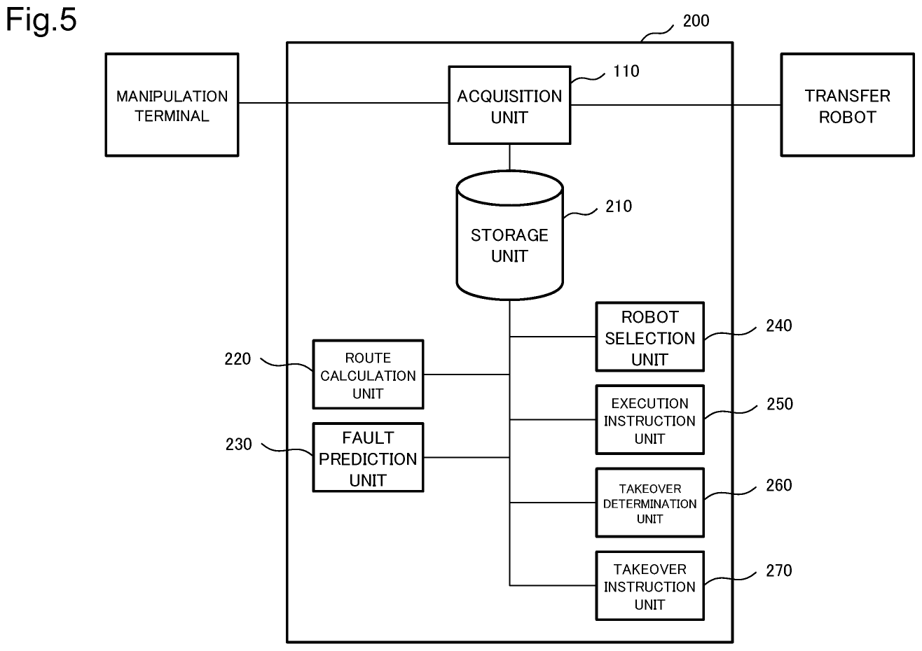

FIG. 5 is a functional block diagram illustrating one example of a functional configuration of the control device 200 according to the present example embodiment. As illustrated in FIG. 5, the control device 200 according to the present example embodiment includes an acquisition unit 110, a storage unit 210, a route calculation unit 220, a fault prediction unit 230, a robot selection unit 240, an execution instruction unit 250, a takeover determination unit 260, and a takeover instruction unit 270.

The acquisition unit 110 acquires operation information from a manipulation terminal. The acquisition unit 110 stores the acquired operation information in the storage unit 210.

The acquisition unit 110 also acquires state information from a transfer robot. The acquisition unit 110 stores the acquired state information in the storage unit 210.

When the acquisition unit 110 acquires operation information, the execution instruction unit 250 calculates a travel route from an operation start point to an operation end point in the operation information by use of the route calculation unit 220 to be described later. The execution instruction unit 250 selects, by use of the robot selection unit 240 to be described later, a transfer robot that is instructed to execute an operation indicated by the operation information (a transfer robot being an allocation destination to which an operation is allocated). The execution instruction unit 250 transmits the operation information and the travel route to the transfer robot being an allocation destination, and instructs the transfer robot to execute the operation from the operation start point.

Thus, the transfer robot being an allocation destination executes the transfer operation by moving to the operation start point, loading a transfer article, and moving along with the travel route, based on the received operation information.

The execution instruction unit 250 generates information relating to allocation of an operation to the transfer robot (hereinafter, also described as allocation information).

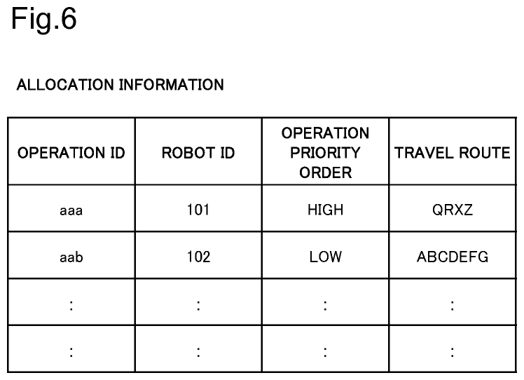

FIG. 6 is a table illustrating one example of allocation information used in the present example embodiment. Allocation information includes, but is not limited to, for example, an operation ID, a robot ID, an operation priority order, and a travel route as illustrated in FIG. 6, and may include other information included in operation information and state information. The control device 200 is able to recognize, based on an operation ID and a robot ID being associated with each other and included in allocation information, an operation being executed by each transfer robot.

The execution instruction unit 250 may transmit allocation information and the like to a manipulation terminal.

The takeover determination unit 260 determines whether each transfer robot is able to accomplish an operation, by watching a state of each transfer robot executing the operation, and determines necessity of takeover of the operation. For example, the takeover determination unit 260 determines, based on state information of each transfer robot stored in the storage unit 210, whether the transfer robot is able to accomplish an operation.

A method of determining necessity of takeover is not particularly limited. For example, the takeover determination unit 260 may determine necessity of takeover, based on a battery remaining amount at a current point of a transfer robot executing an operation. In this case, the takeover determination unit 260 acquires, from, for example, state information, a battery remaining amount and a current position of a transfer robot executing an operation. The takeover determination unit 260 acquires a travel route from allocation information. The takeover determination unit 260 calculates predictive power use up to an operation end point at a current point (i.e., predictive power consumption necessary for a remaining operation), based on a current position and a travel route. As described later, predictive power use is calculated, for example, based on past travel data.

When a value in which predictive power use is subtracted from a battery remaining amount is equal to or more than a predetermined threshold value, a transfer robot is able to accomplish an operation, and therefore, the takeover determination unit 260 determines that there is no necessity of takeover of the operation. When a value in which predictive power use is subtracted from a battery remaining amount is less than a predetermined threshold value, a transfer robot is not able to accomplish an operation, and therefore, the takeover determination unit 260 determines that there is a necessity of takeover of the operation.

When the takeover determination unit 260 determines that a transfer robot executing an operation is not able to accomplish the operation, the takeover instruction unit 270 performs takeover instruction processing below, with regard to the operation (hereinafter, also described as an operation targeted for takeover) being executed by the transfer robot (hereinafter, also described as a takeover-source transfer robot).

The takeover instruction unit 270 selects, by use of the robot to selection unit 240 to be described later, a transfer robot taking over an operation determined not to be able to be accomplished (hereinafter, also described as a takeover-destination transfer robot). The takeover instruction unit 270 instructs a takeover-source transfer robot to have the operation taken over by a takeover-destination transfer robot at a takeover point (a current position of the takeover-source transfer robot).

The takeover instruction unit 270 transmits operation information and a travel route to the takeover-destination transfer robot, and instructs the takeover-destination transfer robot to take over an operation from the takeover-source transfer robot at the takeover point. Thus, the takeover-source transfer robot hands over a transfer article to the takeover-destination transfer robot at the takeover point.

The takeover-destination transfer robot executes a transfer operation (takes over the transfer operation) by moving to the takeover point, receiving a transfer article from the takeover-source transfer robot, and moving along with a travel route.

The takeover instruction unit 270 updates allocation information with a robot ID of the takeover-destination transfer robot.

The takeover instruction unit 270 may set a position other than a current position of the takeover-source transfer robot as a takeover point. For example, the takeover instruction unit 270 may determine a takeover point, based on a current position of a takeover-source transfer robot, a charging place, and a current position of a takeover-destination transfer robot. In this case, the takeover instruction unit 270 acquires a current position of a takeover-source transfer robot with reference to state information. Based on an evaluation function (weight function) having, as parameters, a current position of a takeover-source transfer robot, a charging place, and a current position of a takeover-destination transfer robot, the takeover instruction unit 270 calculates, as a takeover point, such a point that a distance between the three points becomes minimum.

In consideration of a time when a takeover-source transfer robot arrives at a takeover point after starting an operation, the takeover instruction unit 270 may instruct a takeover-destination transfer robot to arrive at the takeover point before the time.

A takeover-source transfer robot may be previously set in such a way as to go to a nearest or designated charging place after takeover of an operation. Alternatively, when being selected by the robot selection unit 240, a takeover-source transfer robot may be instructed in such a way as to go to a nearest or designated charging place after takeover of an operation.

The storage unit 210 stores, for example, operation information as illustrated in FIG. 3. The storage unit 210 stores, for example, state information as illustrated in FIG. 4. The storage unit 210 stores allocation information as illustrated in FIG. 6 in which operation information and state information are associated with each other by the acquisition unit 110.

The storage unit 210 further stores, for each past operation, travel data of a transfer robot allocated to the operation. For example, the storage unit 210 may store, as travel data, information in which a fault possibility of a transfer robot during operation execution to be described later and an actual travel route in each operation are added to information associating a history of operation information with a history of state information.

A history of state information to be used for travel data may include all pieces of state information transmitted from a transfer robot executing an operation, or may include state information received at least at operation start and at operation end, out of state information transmitted from a transfer robot. Thus, when necessary, for example, remaining amounts of a battery at operation start and operation end, a fault possibility to be described later, presence or absence of occurrence of an unexpected event and a kind thereof, an operation time, and a movement speed can be calculated, based on a history of state information.

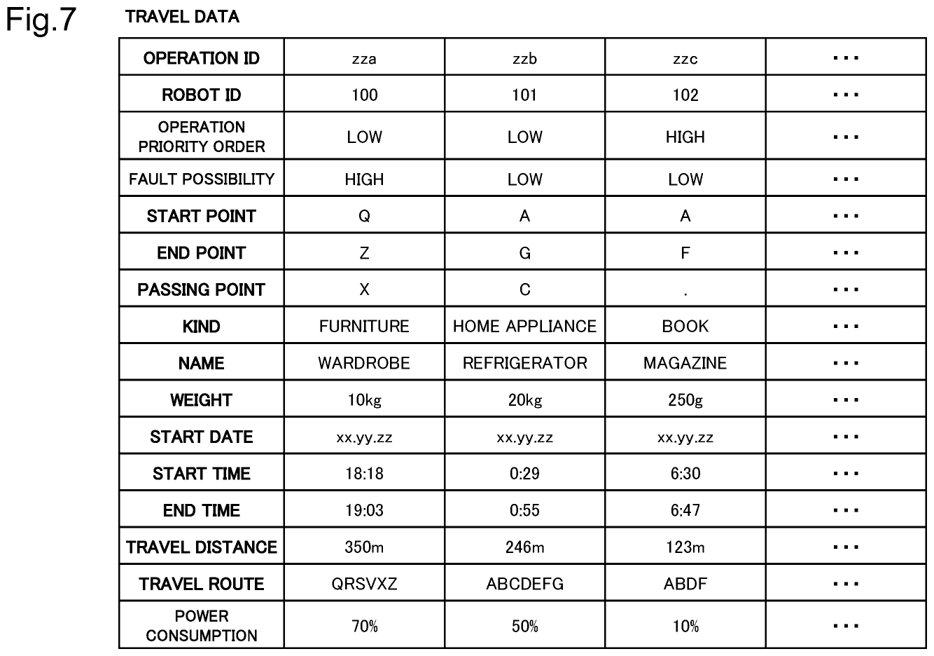

FIG. 7 is a diagram illustrating one example of travel data stored in the storage unit 210. In the present example embodiment, past operation information, histories of an operation start time and an operation end time included in state information, and a travel distance and power consumption that can be calculated from the histories are stored as travel data relating to a past operation.

The storage unit 210 may store information, a program, and data necessary for an action of the control device 200.

Travel data may be stored in the same storage device (e.g., the storage unit 210), or may be stored in storage devices different from each other.

Further, the storage unit 210 may be built in the control device 200, or may be achieved by a storage device being separate from the control device 200.

The fault prediction unit 230 predicts a fault possibility of each transfer robot, with reference to travel data stored in the storage unit 210. While a method by which the fault prediction unit 230 predicts a fault possibility is not particularly limited, a fault possibility may be predicted according to a total movement distance of each transfer robot within a predetermined period. Herein, a predetermined period may be determined according to a use frequency of a transfer robot, such as one month or half a year, or may be determined based on a fault rate curve from past fault data.

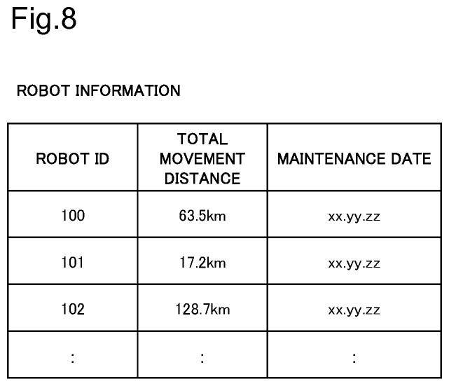

Alternatively, the fault prediction unit 230 may predict a fault possibility according to an elapsed period from a previous maintenance date of a transfer robot. In this case, as illustrated in FIG. 8, robot information including a total movement distance and a maintenance date may be stored in the storage unit 210, with regard to each transfer robot. A fault possibility may be represented at two or more levels, and may be represented at, for example, three high, medium, and low levels, or may be classified into and represented at finer levels.

Herein, a total movement distance of each transfer robot is able to be calculated from, for example, a travel route included in travel data stored in the storage unit 210. The fault prediction unit 230 is able to store a calculated fault possibility as, for example, allocation information in the storage unit 210, by associating the calculated fault possibility with a robot ID of each transfer robot.

The route calculation unit 220 calculates a travel route of a transfer robot from an operation start point to an operation end point, based on operation information acquired from a manipulation terminal by the acquisition unit 110. The route calculation unit 220 may determine, as a travel route, a shortest route from an operation start point to an operation end point. A method by which the route calculation unit 220 calculates a travel route is not particularly limited, and a general route search method based on a graph theory or the like may be used. When operation information includes a passing point, the route calculation unit 220 may determine, as a travel route, a shortest route in which the passing point is also considered.

The robot selection unit 240 selects a transfer robot to which an operation is allocated or which performs takeover of an operation (a transfer robot being an allocation destination or a takeover-destination of an operation), in response to a request from the execution instruction unit 250 or the takeover instruction unit 270.

Herein, the execution instruction unit 250 requests the robot selection unit 240 for selection of a transfer robot, by designating, as a “target operation”, an operation ID of an operation included in acquired operation information, and designating, as a “target position”, a start position of an operation. The takeover instruction unit 270 requests selection of a transfer robot, by designating, as a “target operation”, an operation ID of an operation targeted for takeover, and designating, as a “target position”, a current position of a takeover-source transfer robot. The robot selection unit 240 selects a transfer robot, based on the designated target operation and target position.

The robot selection unit 240 determines whether a transfer robot having no operation allocated thereto and waiting (or being charged) at a waiting place or the like (hereinafter, also described as a waiting transfer robot) exists in a predetermined range from a target position. The predetermined range may be, for example, a range at a predetermined distance from a target position, or may be a range requiring a predetermined time. The predetermined range may also be inside of a section including a target position, or may be a range including the section and an adjacent section. When a waiting transfer robot exists, the robot selection unit 240 selects the waiting transfer robot.

When no waiting transfer robot exists, the robot selection unit 240 determines whether a transfer robot executing an operation having a lower operation priority order than a target operation exists in a predetermined range from a target position. When such a transfer robot exists, the robot selection unit 240 selects, from among the transfer robots, a transfer robot executing an operation having the lowest operation priority order. When a plurality of transfer robots executing operations having the lowest operation priority orders exist, the robot selection unit 240 may select a nearest transfer robot to a target position.

Thus, when attempting to select a transfer robot executing an operation (hereinafter, also described as a selection target transfer robot) as a transfer robot being an allocation destination or a takeover destination of an operation, the robot selection unit 240 may recursively execute the above-described takeover instruction processing by the takeover instruction unit 270, with regard to the operation of the selection target transfer robot. Thus, even when a selection target transfer robot is executing an operation, the operation is further taken over by another transfer robot, and yet the selection target transfer robot is able to be selected as a transfer robot being an allocation destination or a takeover destination of an operation.

When selecting a transfer robot from a waiting transfer robot and a transfer robot executing an operation, the robot selection unit 240 may select a transfer robot, further based on predictive power use from a target position to an operation end point of a target operation, and a battery remaining amount of each transfer robot.

Predictive power use is calculated based on, for example, past travel data. In this case, the robot selection unit 240 may calculate predictive power use, based on power consumption relative to a travel distance of a transfer robot. For example, the robot selection unit 240 calculates, from past travel data, average power consumption relative to travel distances of a plurality of transfer robots. The robot selection unit 240 acquires a travel route from allocation information of a target operation. The robot selection unit 240 then calculates predictive power use by use of a distance from a target position to an operation end point of a travel route of the target operation, and average power consumption.

The robot selection unit 240 may calculate predictive power use, based on travel data relating to an operation similar to a target operation. For example, the robot selection unit 240 acquires a travel route from allocation information of a target operation. The robot selection unit 240 also acquires operation information of the target operation. The robot selection unit 240 extracts, from past travel data, the same or similar travel data, with, as keys, a route from a target position to an operation end point of a travel route of the target operation, and an operation content (e.g., a weight or the like) of the target operation. The robot selection unit 240 acquires, from the extracted travel data, power consumption actually consumed in a past operation being the same or similar to the target operation. When the travel data do not include actual power consumption, the robot selection unit 240 may calculate actual power consumption from a battery remaining amount at operation start and a battery remaining amount at operation end. The robot selection unit 240 determines, as predictive power use, power consumption actually consumed in a past operation being the same or similar to the target operation.

The robot selection unit 240 acquires a battery remaining amount in state information, with regard to each of a waiting transfer robot and a transfer robot executing an operation having a lower operation priority order than a target operation, that are located in a predetermined range from a target position. The robot selection unit 240 compares predictive power use with the acquired battery remaining amount of each transfer robot. When the battery remaining amount of the waiting transfer robot or the transfer robot executing the operation is beyond the predictive power use, the robot selection unit 240 selects the transfer robot.

The robot selection unit 240 may further select a transfer robot in consideration of a fault possibility predicted by the fault prediction unit 230 as well. For example, when a plurality of waiting transfer robots or transfer robots executing operations having lower operation priority orders than a target operation exist, the robot selection unit 240 may select a transfer robot having the lowest fault possibility.

When a plurality of waiting transfer robots or transfer robots executing operations having lower operation priority orders than a target operation exist, the robot selection unit 240 may further select a nearest transfer robot from a target position.

It is considered that travel data stored in the storage unit 210 have an error in a value of power consumption for reasons such as an individual difference of individual transfer robots associated with travel data to be referred to, aged deterioration of a charging battery, a difference of an environment where an operation is executed, and occurrence of a fault. Thus, the robot selection unit 240 may use travel data by applying thereto statistic processing (e.g., calculating an average value) to a plurality of actual power consumptions acquired from the travel data.

When not being able to find the same past operation content as that of a target operation in the storage unit 210, the robot selection unit 240 extracts, from travel data, an operation in which, for example, a weight and a travel distance of a transfer article are similar, and refers to the extracted travel data. The robot selection unit 240 may calculate predictive power use by multiplying actual power consumptions included in travel data by a value relevant to a ratio of similarity.

### [Action of Control Device 200]

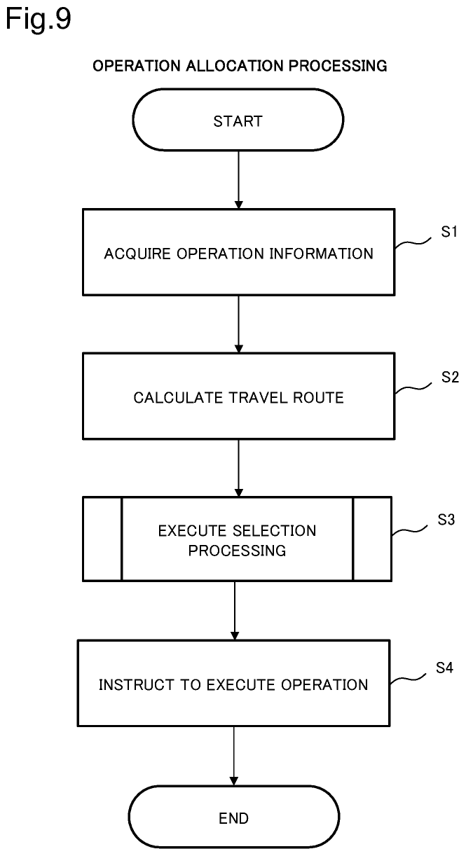

Next, an action of the control device 200 is described with reference to FIGS. 9 to 11.

Herein, it is assumed that the fault prediction unit 230 previously refers to travel data relating to a past operation stored in the storage unit 210, predicts a fault possibility of each transfer robot, and stores the fault possibility in the storage unit 210 in association with a robot ID of each transfer robot.

First, allocation processing of an operation in an action of the control device 200 is described with reference to FIG. 9. FIG. 9 is a flowchart illustrating allocation processing of an operation according to the present example embodiment. Allocation processing of an operation is executed when a user inputs operation information.

The acquisition unit 110 acquires operation information from a manipulation terminal of the user (step S1). Next, the acquisition unit 110 stores the acquired operation information in the storage unit 210.

The execution instruction unit 250 calculates, by use of the route calculation unit 220, a travel route of a transfer robot in an operation, from an operation start point and an operation end point included in the operation information acquired in step S1 (step S2).

The execution instruction unit 250 executes later-described selection processing by the robot selection unit 240, by designating, as a “target operation”, an operation ID of an operation included in the operation information, and designating, as a “target position”, a start position of the operation (step S3). The robot selection unit 240 selects a waiting transfer robot, or a transfer robot executing an operation having a lower operation priority order than a target operation, in a predetermined range from a target position. When a transfer robot executing an operation (selection target transfer robot) is selected, the operation of the selection target transfer robot may be further taken over by another transfer robot by the robot selection unit 240 as described above.

The execution instruction unit 250 instructs the selected transfer robot (a transfer robot being an allocation destination) to execute the operation from the operation start point (step S4). Thus, the selected transfer robot (a transfer robot being an allocation destination) starts an operation of transferring a transfer article from the operation start point.

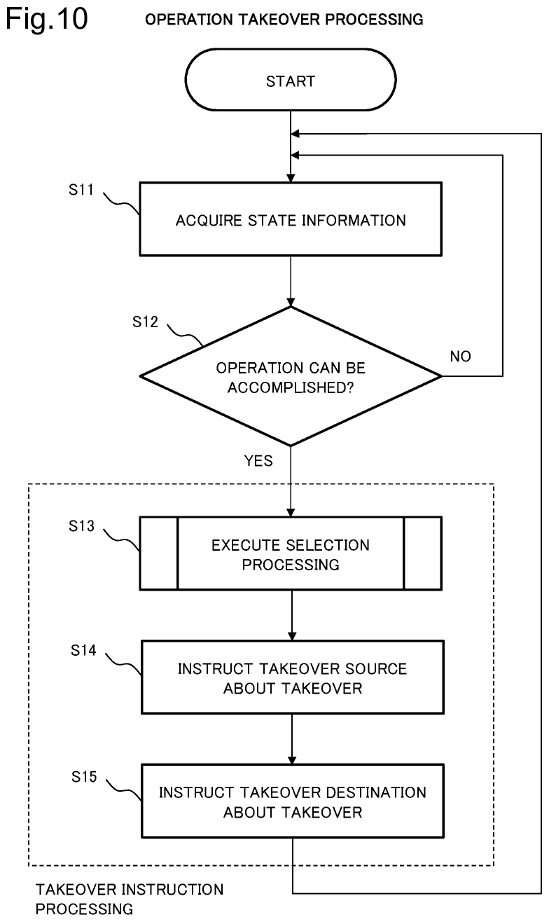

Next, takeover processing of an operation in an action of the control device 200 is described with reference to FIG. 10. FIG. 10 is a flowchart illustrating takeover processing of an operation according to the present example embodiment.

The acquisition unit 110 acquires state information from each transfer robot (step S11). The acquisition unit 110 stores the acquired state information in the storage unit 210.

The takeover determination unit 260 determines, based on the state information of each transfer robot, whether each transfer robot is able to accomplish an operation (step S12). When there is no transfer robot that is not able to accomplish an operation (step S12/NO), processing from step S11 is repeated.

When there is a transfer robot that is not able to accomplish an operation (step S12/YES), the takeover instruction unit 270 executes later-described selection processing by the robot selection unit 240, by designating, as a “target operation”, an operation ID of an operation being executed by a transfer robot that is not able to accomplish the operation (operation targeted for takeover), and designating, as a “target position”, a current position of the transfer robot (takeover-source transfer robot) (step S13). The robot selection unit 240 selects a waiting transfer robot, or a transfer robot executing an operation having a lower operation priority order than a target operation, in a predetermined range from a target position. When a transfer robot executing an operation (selection target transfer robot) is selected, the operation of the selection target transfer robot may be further taken over by another transfer robot, by the robot selection unit 240, as described above.

The takeover instruction unit 270 instructs a takeover-source transfer robot to have the operation taken over by a takeover-destination transfer robot at a takeover point (a current position of the takeover-source transfer robot) (step S14).

The takeover instruction unit 270 instructs the selected transfer robot (takeover-destination transfer robot) to take over an operation from the takeover-source transfer robot at the takeover point (step S15).

Thus, the selected transfer robot (takeover-destination transfer robot) receives a transfer article from the takeover-source transfer robot at the takeover point (the current position of the takeover-source transfer robot), and takes over the transfer operation. Hereinafter, processing from step S11 is repeatedly executed.

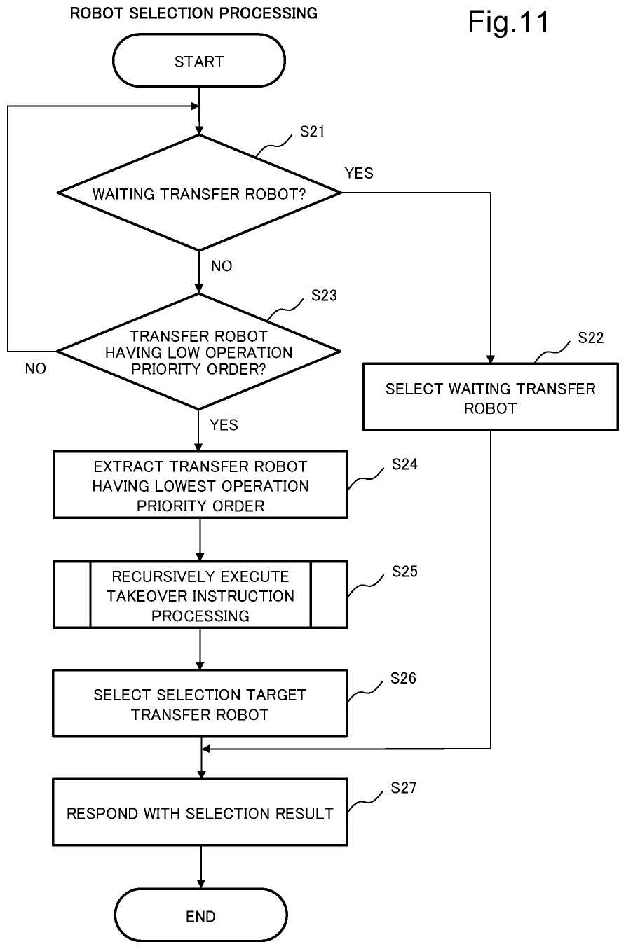

Next, selection processing of a transfer robot in an action of the control device 200 is described with reference to FIG. 11. FIG. 11 is a flowchart illustrating selection processing of a transfer robot according to the present example embodiment.

The selection processing is executed in response to a request from the execution instruction unit 250 or the takeover instruction unit 270.

The robot selection unit 240 determines whether a waiting transfer robot exists in a predetermined range from a target position (step S21). When a waiting transfer robot exists (step S21/YES), the robot selection unit 240 selects the waiting transfer robot (step S22).

When no waiting transfer robot exists (step S21/NO), the robot selection unit 240 determines whether a transfer robot executing an operation having a lower operation priority order than a target operation exists in a predetermined range from a target position (step S23).

When such a transfer robot does not exist (step S23/NO), the robot selection unit 240 repeatedly executes processing from step S21.

When such a transfer robot exists (step S23/YES), the robot selection unit 240 extracts, from among the transfer robots, a transfer robot (selection target transfer robot) executing an operation having the lowest operation priority order (step S24).

The robot selection unit 240 determines a selection target transfer robot as a transfer robot that is not able to accomplish an operation, and recursively executes the above-described takeover instruction processing (steps S13 to S15) by the takeover instruction unit 270, with regard to an operation being executed by the selection target transfer robot (step S25).

When takeover of the operation of the selection target transfer robot by another transfer robot is completed, the robot selection unit 240 selects the selection target transfer robot (step S26). The robot selection unit 240 responds, with a selection result, to the execution instruction unit 250 or the takeover instruction unit 270 (step S27).

In consequence, the action of the control device 200 according to the present example embodiment is completed.

### Advantageous Effect

In the control device 200 according to the present example embodiment, the takeover determination unit 260 is able to determine necessity of takeover, for a transfer robot executing an operation. The takeover instruction unit 270 is able to select a transfer robot being a takeover destination of an operation, from among transfer robots executing operations having lower operation priority orders than the operation of the transfer robot that is a takeover source of the operation.

The takeover instruction unit 270 is able to have the operation taken over by the selected takeover-destination transfer robot. Thus, the control device 200 according to the present example embodiment is able to continue an operation without interrupting the operation, with priority starting from an operation having a high priority order.

The takeover instruction unit 270 is able to have an operation being executed by the takeover-destination transfer robot further taken over by another transfer robot. By repeating takeover of a transfer robot, the control device 200 according to the present example embodiment is able to continue an operation without interrupting the operation, with priority starting from an operation having a high priority order.

Therefore, the control device 200 according to the present example embodiment is able to appropriately achieve an operation according to a priority order of the operation.

### Modification Example

Next, a modification example of the second example embodiment is described. The modification example of the second example embodiment is based on the second example embodiment described above. For convenience of description, the same reference sign is given to a component having the same function as a component included in the drawings described in the above-described second example embodiment, and description thereof is omitted.

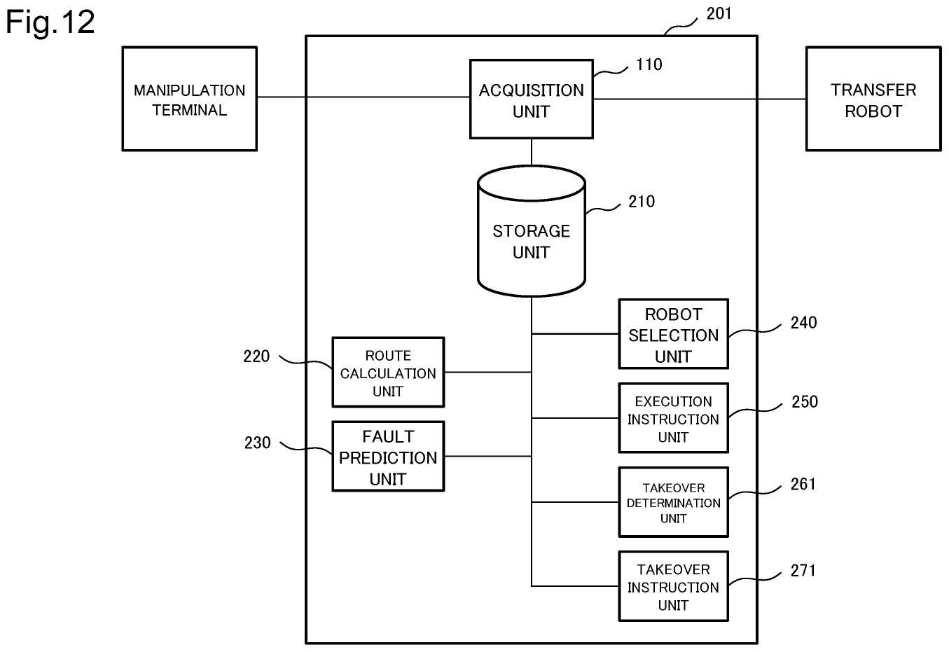

FIG. 12 is a functional block diagram illustrating one example of a functional configuration of a control device 201 according to the modification example of the present example embodiment. As illustrated in FIG. 12, the control device 201 according to the modification example of the present example embodiment includes the takeover determination unit 260 of the control device 200 according to the second example embodiment, and, instead of the takeover instruction unit 270, a takeover determination unit 261, and a takeover instruction unit 271.

In the control device 200 according to the second example embodiment described above, a takeover-source transfer robot has such a battery remaining amount as to arrive at a nearest or designated charging place. The control device 201 according to the modification example of the present example embodiment has a configuration that copes with a case where an unexpected event (failure) such as an error, a fault, or an accident occurs in a transfer robot executing an operation, and the transfer robot executing the operation stops and interrupts the operation.

When an unexpected event occurs in a transfer robot executing an operation, the transfer robot executing the operation notifies the control device 201 of the failure occurrence. The control device 201 inputs the received failure occurrence information to the takeover determination unit 261. The takeover determination unit 261 determines that the transfer robot notifying of the failure occurrence is not able to accomplish the operation.

For notification of failure occurrence, for example, failure information included in state information transmitted to the control device 201 from a transfer robot may be used. For example, failure occurrence information indicating a current position of a transfer robot executing an operation stopped due to a failure, a kind of failure, and a priority order of the interrupted operation may be used.

The takeover instruction unit 271 executes selection processing by the robot selection unit 240, by designating, as a “target operation”, an operation ID of an operation being executed by a transfer robot in which a failure has occurred, and designating, as a “target position”, a current position (stop point) of the transfer robot (takeover-source transfer robot). The takeover instruction unit 271 instructs the selected transfer robot (takeover-destination transfer robot) to take over an operation from the takeover-source transfer robot at the takeover point (stop point).

The control device 201 notifies a manipulation terminal of a user of failure occurrence. When receiving the notification of the failure occurrence, the manipulation terminal generates an alarm in order to inform the user of occurrence of a failure. A method of generating an alarm is not particularly limited. For example, a message that a failure has occurred may be displayed in a display unit included in the manipulation terminal, or the user may be notified with sound, light, or the like further added thereto.

The manipulation terminal may display, on the display unit, a position of a transfer robot stopped due to a failure, a kind of failure, and operation information of the interrupted operation, in addition to the message of the failure occurrence. Thus, the user is able to cope with a transfer robot that is not able to autonomously travel due to occurrence of a failure.

### Advantageous Effect

In the control device 201 according to the modification example of the present example embodiment, even when a transfer robot executing an operation stops due to a failure, the takeover instruction unit 271 is able to select a transfer robot being a takeover destination of an operation near a stop point, and have the operation taken over by the transfer robot.

The control device 201 according to the modification example of the present example embodiment is able to continue an operation with minimum necessary interruption, with priority starting from an operation having a high priority order, even when a failure occurs unexpectedly.

Therefore, the control device 201 according to the modification example of the present example embodiment is able to obtain an advantageous effect similar to that of each of the control devices according to the first and second example embodiments described above.

### <Configuration Example of Hardware>

Herein, a configuration example of hardware that can achieve a control device (100, 200, 201) according to each of the above-described example embodiments is described. The above-described control device (100, 200, 201) may be achieved as a dedicated device, but may be achieved by use of a computer (information processing device).

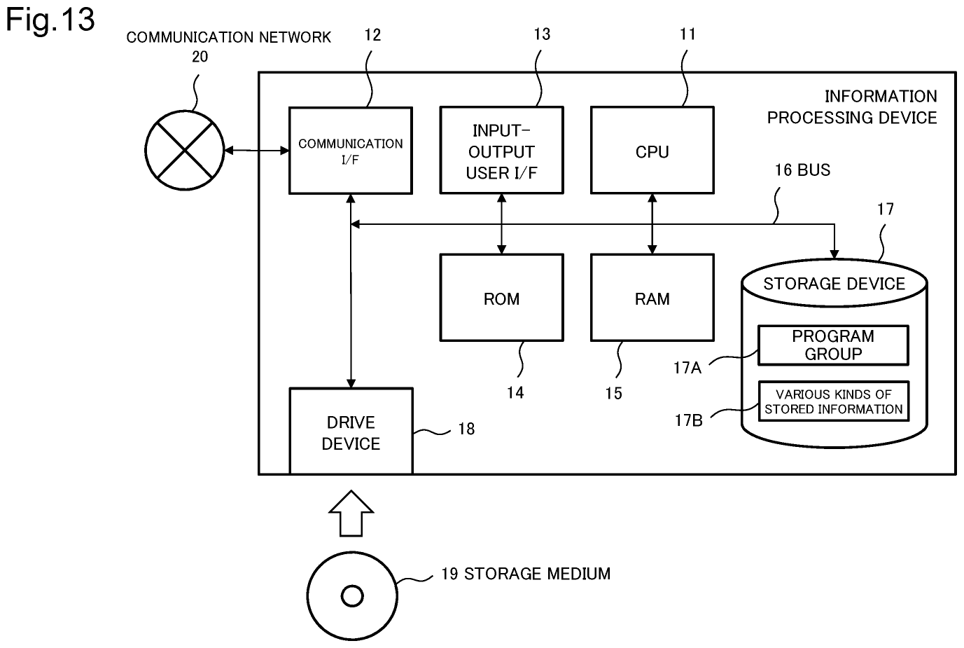

FIG. 13 is a diagram exemplifying a hardware configuration of a computer (information processing device) that can achieve each of the example embodiments of the present invention.

Hardware of an information processing device (computer) 10 illustrated in FIG. 13 includes a central processing unit (CPU) 11, a communication interface (I/F) 12, an input-output user interface 13, a read only memory (ROM) 14, a random access memory (RAM) 15, a storage device 17, and a drive device 18 of a computer-readable storage medium 19, and has a configuration in which the components are connected via a bus 16. The input-output user interface 13 is a man-machine interface such as a keyboard being one example of an input device or a display as an output device. The communication interface 12 is a general communication means for a device according to each of the above-described example embodiments (FIGS. 1, 2, 5, and 12) to communicate with an external device via a communication network 20. In the hardware configuration, the CPU 11 takes overall control, with regard to the information processing device 10 that achieves the control device (100, 200, 201) according to each of the example embodiments.

The present invention described with each of the above-described example embodiments as an example is achieved, for example, by supplying a program (computer program) that can achieve processing described in each of the above-described example embodiments to the information processing device 10 illustrated in FIG. 13, and then reading in the CPU 11 and executing the program. The program may be, for example, a program that can achieve each kind of processing described in the flowcharts (FIGS. 9 to 11) referred to in the description of each of the above-described example embodiments, or each unit (each block) illustrated in the device in the block diagrams illustrated in FIGS. 1, 2, 5, and 12.

The program supplied into the information processing device 10 may be stored in a readable-writable transitory storage memory (15) or a non-volatile storage device (17) such as a hard disk drive. Specifically, in the storage device 17, a program group 17A is, for example, a program that can achieve a function of each unit illustrated in the control device (100, 200, 201) according to each of the above-described example embodiments. Various kinds of stored information 17B are, for example, travel data or the like relating to a past operation content in each of the above-described example embodiments. At implementation of a program into the information processing device 10, a constitutional unit of an individual program module is not limited to segmentation of each block illustrated in the block diagrams (FIGS. 1, 2, 5, and 12), and may be suitably selected by a person skilled in the art at implementation.

In the case described above, for a method of supplying a program into the device, a general procedure is able to be adopted at present, such as a method of installing into the device via various computer-readable recording media (19) such as a compact disk (CD)-ROM or a flash memory, or a method of downloading from outside via a communication line (20) such as the Internet. In such a case, it can be considered that the present invention is configured by a code (the program group 17A) constituting the computer program, or the storage medium (19) storing the code.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. A control device comprising:
a memory storing instructions; and
one or more processors configured to execute the instructions to:
acquire a priority order of an operation being executed by each of a plurality of robots; and
select, among the plurality of robots, a robot executing a second operation having a lower priority order than a first operation being to executed by a first robot, as a second robot that takes over and executes the first operation, when the first robot is not able to arrive at an end point of the first operation, and
instruct the second robot to take over the first operation.

2. The control device according to claim 1, wherein the one or more processors are configured to execute the instructions to:
select the second robot when a battery remaining amount of the first robot is not sufficient in order to arrive at an end point of the first operation.

3. The control device according to claim 2, wherein the one or more processors are configured to execute the instructions to:
determine a takeover point of the first operation, based on a position of the first robot and a position of the second robot, and
instruct the first robot and the second robot to take over the first operation at the determined takeover point.

4. The control device according to claim 1, wherein the one or more processors are configured to execute the instructions to:
select the second robot when a failure occurs in the first robot.

5. The control device according to claim 4, wherein the one or more processors are configured to execute the instructions to:
determine, as a takeover point of the first operation, a point where the first robot exists, and
instruct the second robot to move to the determined takeover point, and take over the first operation at the determined takeover point.

6. The control device according to claim 1, wherein the one or more processors are configured to execute the instructions to:
select the second robot, based on a fault possibility of each of the plurality of robots.

7. The control device according to claim 1, wherein the one or more processors are configured to execute the instructions to:
select, as the first robot that executes the first operation, a robot executing an operation having a lower priority order than the first operation input from a user, and
instruct the first robot to execute the first operation from a start point of the first operation.

8. The control device according to claim 1, wherein the one or more processors are configured to execute the instructions to:
further select, as a third robot that takes over and executes the second operation, a robot executing a third operation having a lower priority order than the second operation, and
instruct the third robot to take over the second operation.

9. A control method comprising:
acquiring a priority order of an operation being executed by each of a plurality of robots;
selecting, among the plurality of robots, a robot executing a second operation having a lower priority order than a first operation being executed by a first robot, as a second robot that takes over and executes the first operation, when the first robot is not able to arrive at an end point of the first operation; and
instructing the second robot to take over the first operation.

10. A non-transitory recording medium recording thereon a computer program, causing a computer to execute:
acquisition processing of acquiring a priority order of an operation being executed by each of a plurality of robots;
selection processing of selecting, among the plurality of robots, a robot executing a second operation having a lower priority order than a first operation being executed by a first robot, as a second robot that takes over and executes the first operation, when the first robot is not able to arrive at an end point of the first operation; and
takeover instruction processing of instructing the second robot to take over the first operation.
